(19) United States
(12) Patent Application Publication
(10) Pub. No.: US 2007/0029265 A1
(43) Pub. Date: Feb. 8, 2007

(54) Ultra violet water treatment device and system

(76) Inventor: Edward Murray Gale, Delray Beach, FL (US)

Correspondence Address: EDWARD GALE, 7168 CATALUNA CIRCLE, DELRAY BEACH, FL, 33446, US

(21) Appl. No.: 11/198,571

(22) Filed: Aug. 8, 2005

(51) Int. Cl. C02F 1/32

(52) U.S. Cl. 210/748

(57) ABSTRACT

This invention relates to ultra violet water purification and, more particularly, to a simplified system wherein the output and the effects of the ultra violet lamp is maximized in both irradiating power and duration while the water dwells under the direct rays of the lamps full force, all the while operating without maintenance of any kind.

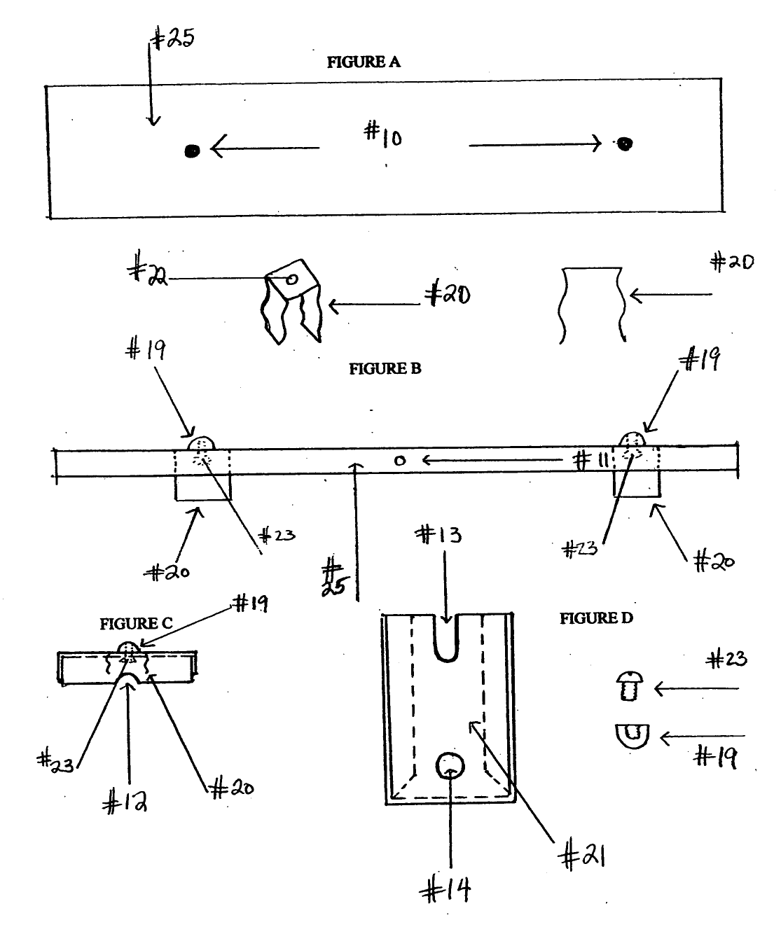

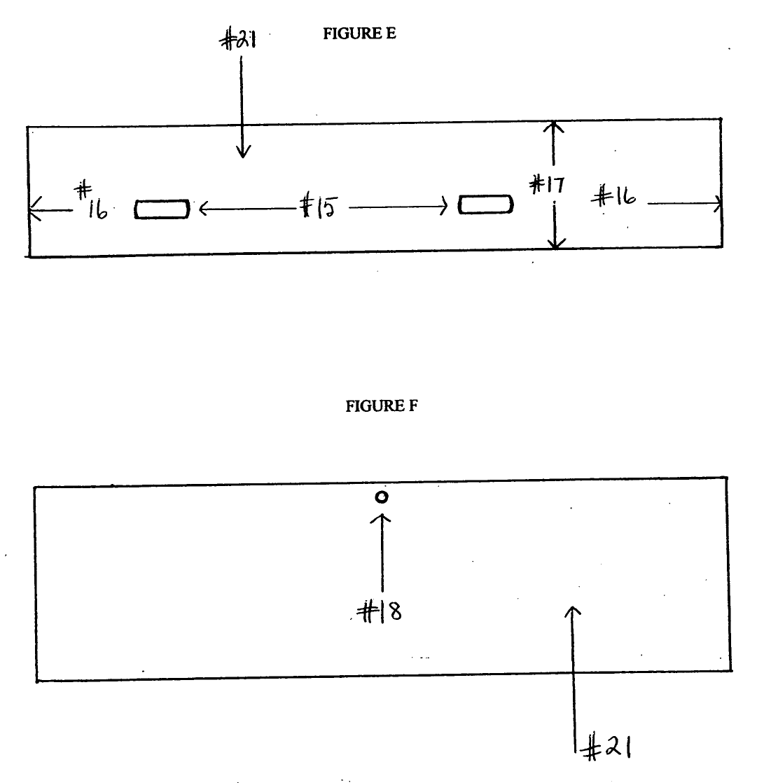

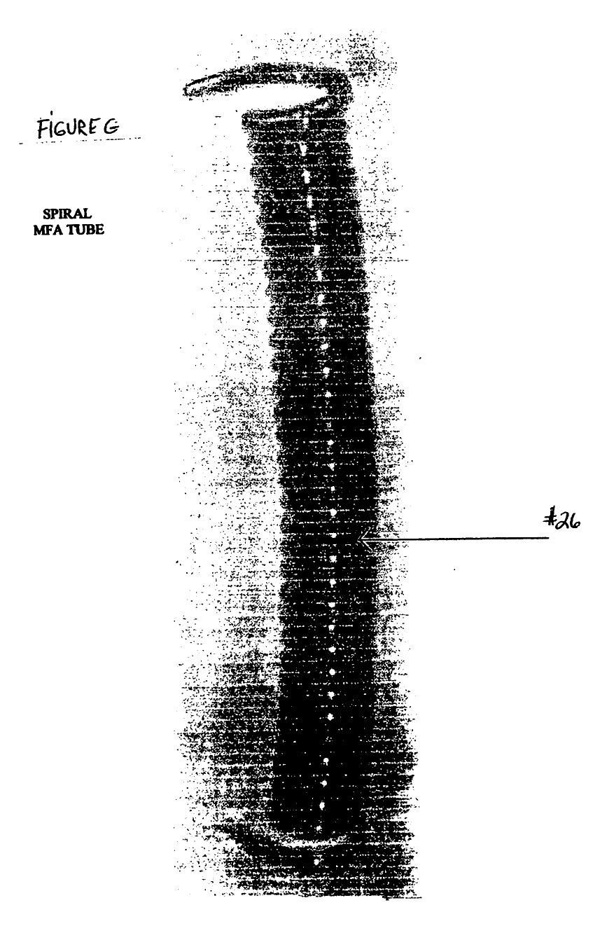

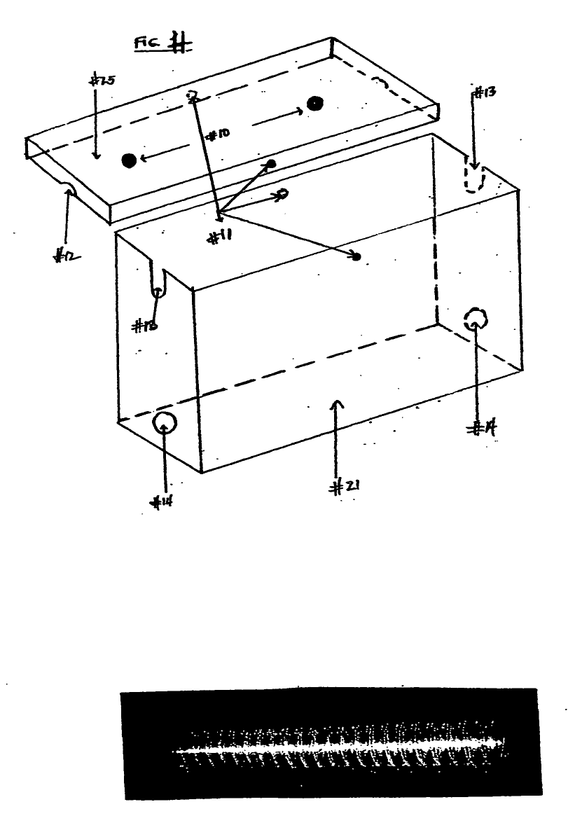

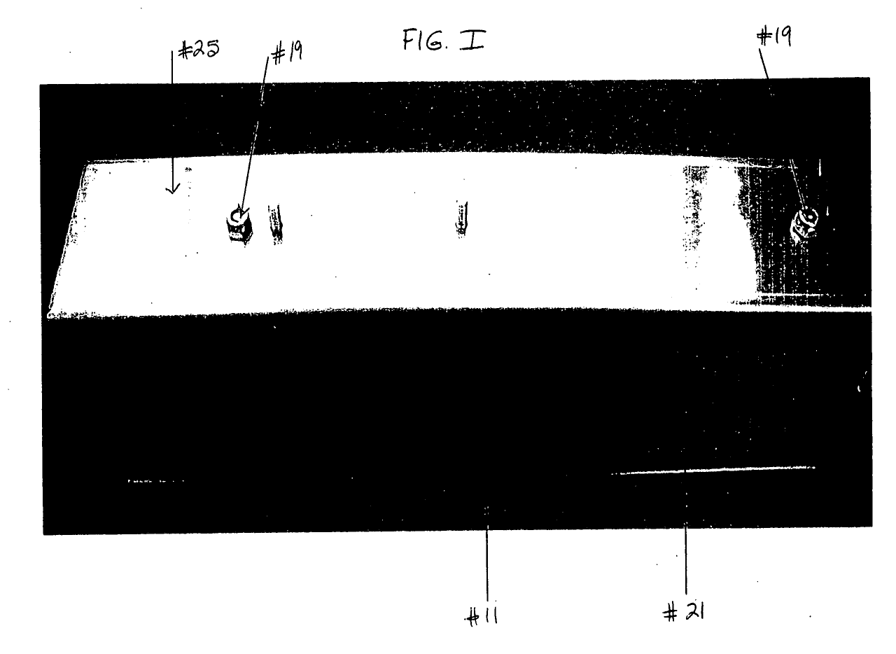

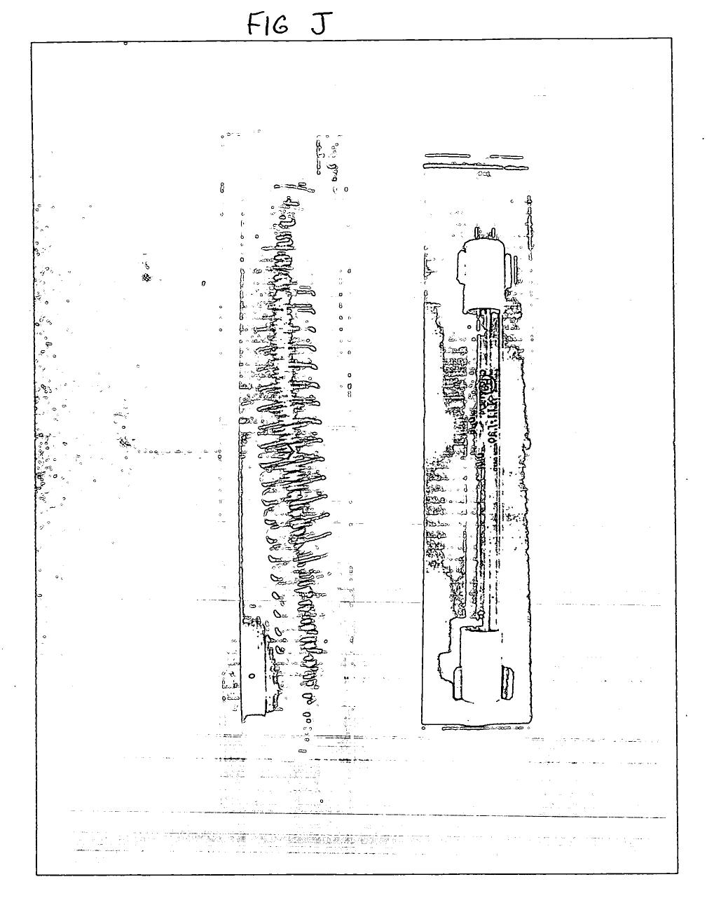

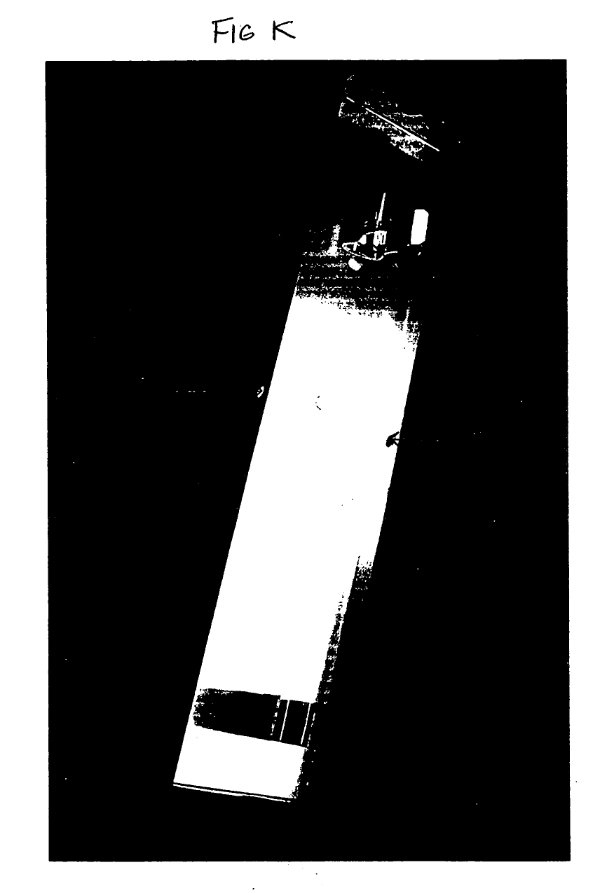

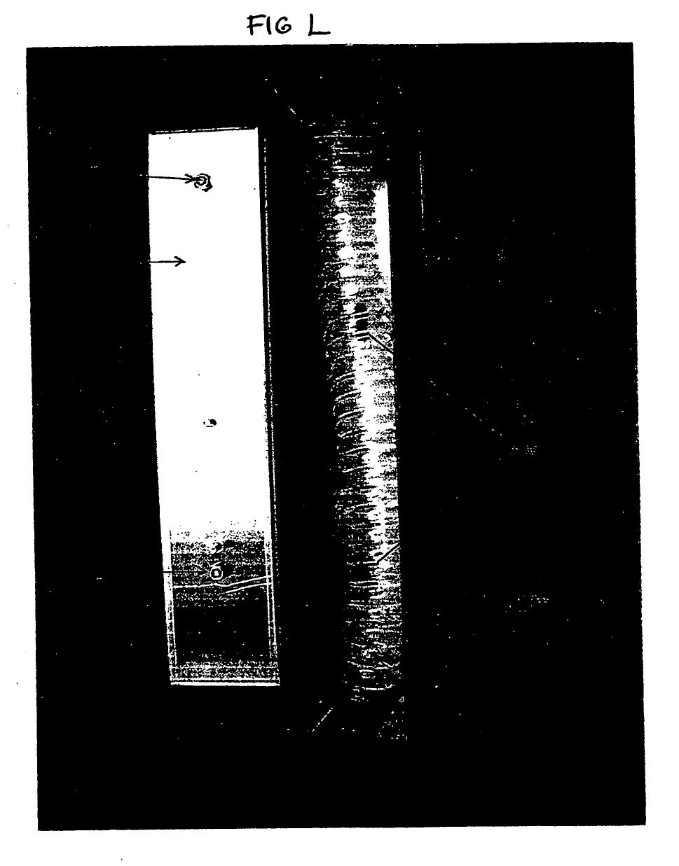

### FIELD OF INVENTION

The following describes an ultraviolet (UV) system design wherein the placement of the lamp, and the manner and method of moving the water, develops significantly higher microbial killing efficiency. The rays emitted by an ultraviolet lamp lose their intensity, and consequently becomes less effective, the further away it is placed from the contaminated liquid. This system constantly maintains the presence of the UV lamp within one-half (½) inch of the liquid. Additionally the water dwells under the full power of the lamp while it travels over 6 feet in a circular fashion. This circular motion exposes the bacteria and other living organisms in such a manner, that even if they form clumps, (shadowing) they will receive a sizeable dose of UV irradiation. Since the lamp itself is not immersed in water or encased in any sleeve, the full and undiminished power of the irradiation will be focused on the contaminated fluid. Not insignificant is the type of material being used for the tubing. It must first, naturally, allow the UV rays to pass through without any reduction in its power. Additionally, it must be able to resist the deteriorating effect of the UV rays but also be flexible to allow for the forming of the tubing in the manufacturing process. The tubing used in our system is made from MFA copolymers, which has been approved for use and contact in the food processing industry. It may properly be used in these applications in full compliance with the Federal Food, Drug and Cosmetic Act. The exact dimensions will vary based upon the application. It can be coiled on a mandrel. Furthermore, the diameter of the ends, or tips of the tubing, must be a true round and size to allow for the use of standard sized plumbing fittings normally used in the transport of the liquid being treated. The material in use is resistant to numerous products having many varied types of chemical composition, thereby allowing for a broader usefulness of this system design. The entire system is encased in a high-gloss metal, rectangular shaped container to prevent a viewers' exposure to the ultraviolet rays. The high gloss inside finish of the reflective material allows for full 360 degree UV treatment at a very high rate since the overall measurements of the container is 10¾″ wide by 3″ high by 2″ deep. Even though the lamp diminishes in its irradiation effectiveness due to the passage of time, the closeness of the lamp placement in relation to the fluid, the very small confined area in which the lamp and the liquid are confined, the ability of the case material to reflect the irradiation in all directions, and the overall length of the circular tubing, means that the net effect will be a higher rate of irradiation for a longer period of the lamps life. Even if the water travels at a high rate the length of the tubing will still allow for maximum effectiveness of the ultraviolet lamp during its useful life.

While the dimensions of the container referred to in the above paragraph are being submitted as part of this submission, this size can be significantly enlarged along with the size of the ultraviolet lamp and circular tubing to allow for use where there is a higher flow rate. By doing this proportionately it will allow for usage in a multitude of systems requiring a high sterilization rate in spite of the higher rate of liquid flow.

### BACKGROUND OF THE INVENTION

Over the last few decades many varied methods have been developed to assist in the purification of water and other fluids. Some of these methods utilize ozone, chemicals, filtration, ultra violet and other mechanical means in order to remove, trap and/or destroy microorganisms. Obviously, no single method is universally accepted since each has its good and bad features. How well these systems function in processing fluids is in direct relation to the volume of fluid being treated. With large municipal treatment facilities chemicals are the only way to economically handle this burden on a daily basis. Hardly a day goes by that there is not some newspaper story relating to problems in this process. Boil water alerts are common, as many as 1000 or more at any given time in the USA and Canada.

It has long been known scientifically that water treated to exposure to ultraviolet radiation renders harmless nearly every know bacteria and virus. This radiation works by destroying the outer cell of the organism thereby rendering it unable to propagate as well as disrupting its ability to obtain food. How effective the radiation is in performing this task is in direct relation to its rated output, the flow rate of the water while it is in contact with the radiation and the dwell time of the water or fluid while it is in contact with the radiation.

In recent years people have been buying treated water in ever growing amounts in order to avoid consuming water from their taps. One of the more popular means of obtaining this treated water is through vending machines strategically placed at sites that make their use quite convenient. Regulations have been promulgated during these years to insure the public's safety. One of these regulations requires that the final stage of treatment within these machines be ultraviolet radiation. It is the purpose of this invention to significantly advance this aspect of the treatment process in order to insure that the public can be confident of receiving a clean and biologically safe product. By eliminating the need for any maintenance during the rated life of the lamp, product quality is consistent and assured. By eliminating the labor involved in normal ultraviolet operations results in significant economic benefits as well as preventing improper sanitizing procedures.

Current U.S. Class: 210/97; 210/143; 210/243; 210/254; 210/748; 250/436; 250/437; 422/24

### REFERENCE CITED

| Patent Number | Date | Inventor | References Cited |
|---|---|---|---|
| 5230792 | July 1993 | Sauska, et al | 210/97 |
| 4968437 | November 1990 | Noll | 210/748 |
| 4798702 | January 1989 | Tucker | 422/24 |
| 6332981 | August 2000 | Loyd | 210/98 |

1. Higher irradiation effective rate due to close proximity of the ultraviolet lamp to the contaminated fluid

2. Higher irradiation effective rate due to the circular motion in which the fluid travels

3. Higher irradiation effective rate due to the reflective material of the encasement thereby negating the effect of “shadowing and “organism clumping.”

4. Higher irradiation effective rate due to the unique composition of the material being used to transport the fluid due to its ability to resist the deteriorating ultraviolet rays, high heat and resistance to a wide range of fluid chemicals.

5. Higher irradiation effective rate due to the distance the fluid travels while under the direct and indirect rays of the ultraviolet lamp

6. Higher irradiation effective rate due to the full power of the ultraviolet rays being concentrated upon the fluid since the lamp is not encased.

7. Higher irradiation effective rate due to the lamp, nor any sleeve, not being immersed in the fluid itself thus eliminating the continuous need for cleaning the surfaces actually coming into contact with the fluid.

8. Higher irradiation effective rate due to the agitation of the water while traveling in the circular tubing. Microscopic contaminants have no place to hide and are thus continually exposed to the ultraviolet rays. High turbulence eliminates “shadowing.”

9. This design allows for rapid lamp changing without the need to shut off the water, thus saving time and labor costs.

10. Higher irradiation rate due to the lamp or sleeve never needing any cleaning when operating inside a housing.
